(19) United States
(12) Patent Application Publication
(10) Pub. No.: US 2008/0296100 A1
(43) Pub. Date: Dec. 4, 2008

(54) Elevator Panel And Elevator Car Using The Same

(75) Inventors: Hae-sik Lee, Gwangju (KR); Bong-jun Lee, Gwangju (KR)

Correspondence Address: QUINN LAW GROUP, PLLC, 39555 ORCHARD HILL PLACE, SUITE # 520, NOVI, MI, 48375, US

(73) Assignees: MATERIAL SCIENCES CORPORATION, Elk Grove Village, IL (US); HAEWON MSC CO., LTD, Jeollanam-do (KR)

(21) Appl. No.: 12/130,218

(22) Filed: May 30, 2008

(30) Foreign Application Priority Data
May 31, 2007 (KR) 10-2007-0053522

(51) Int. Cl. B66B 11/02; E04C 2/54

(52) U.S. Cl. 187/401; 52/783.1

(57) ABSTRACT

An elevator panel having excellent sound-absorbing and vibration-damping characteristics, and an elevator car using the same. The elevator panel includes a surface plate; a backing plate backing the surface plate; and an adhesive resin interposed between the surface plate and the backing plate to bond the surface plate and the backing plate with each other, wherein the adhesive resin has a thickness from about 0.02 mm to about 0.1 mm. Thereby, the elevator panel can reduce the cost of production, provide an external appearance equal to that of the conventional elevator panel formed of expensive metal material, and produce excellent effects of isolating and absorbing sounds such as noise from the outside.

### CROSS-REFERENCE TO RELATED APPLICATIONS

This application claims priority to Korea Patent Application 10-2007-0053522, filed May 31, 2007.

### TECHNICAL FIELD

The present invention relates generally to elevator panels, and more particularly, to elevator parts having sound-absorbing and vibration-damping characteristics, and an elevator car using the same.

### BACKGROUND OF THE INVENTION

In general, the jamb, the entrance, the car internal finishing material, and the car door of an elevator are fabricated from metal materials such as steel, stainless steel and copper, and some high-class buildings have recently used high-grade materials such as titanium. In the case of using stainless steel, copper, titanium, etc. for the jamb, the entrance, the car internal finishing material, and the car door of an elevator, the stainless steel provides an elegant surface but can also maximize external appearance through surface treatment. Furthermore, stainless steel can minimize corrosion due to its own corrosion resistance. In similar regard, copper provides fine external appearance due to its own brilliance and corrosion resistance.

However, in spite of such advantages, stainless steel, copper, titanium and the like are very expensive, and thus are merely used for high-class buildings. Although these materials are good for external appearance, these materials themselves are deficient in sound-absorbing and vibration-damping characteristics.

As apartments are made high-rise, noise and vibration resulting from the operation of the elevator become an issue to passengers of the elevator as well as households adjacent to a machine room or a hoistway. This issue is becoming more serious due to speed-up of the elevator, increase in the number of round trips of the elevator, increase in the requirements of residents, and so on. The noise and vibration of the elevator are divided into air-borne sound in which the sounds generated by the operation of the elevator are propagated through air particles in a sound wave form, and structure-borne sound in which the sounds generated by the operation of the elevator are conducted through a ceiling, a wall, and a floor via a structural space of the building. Conventionally, in order to reduce such noise and vibration, the back of the car internal finishing material is adhered with a separate tape or is covered with paint. This additional process results in producing a very slight effect, and is responsible for increasing the cost of production.

Further, in the case of using inexpensive ordinary steel, the ordinary steel reduces the cost burden, but it is vulnerable to corrosion. Thus, ordinary steel may require the surface thereof be applied with enamel paint, which may deteriorate the external appearance of the elevator.

### SUMMARY OF THE INVENTION

The present invention applies a bonded plate, which is inexpensive and has excellent external appearance and simultaneously excellent sound-absorbing and vibration-damping characteristics, to an elevator panel, so that even a surface plate, which is exposed to the outside can secure fine external appearance through surface treatment and surface machining, and results in developing the elevator panel, the bonded plate, by producing the backing plate, which is not exposed to the outside, using a relatively inexpensive material, and then bonding a surface plate with the backing plate using an adhesive resin having excellent sound-absorbing and vibration-damping characteristics, as well as an elevator car using the same.

Accordingly, the present invention provides an elevator panel by using a bonded plate, which includes a surface plate and backing plate bonded together using an adhesive resin having excellent sound-absorbing and vibration-damping characteristics, thereby achieving sound-absorbing and vibration-damping functions from the adhesive resin layer of the bonded plate, reducing the cost of production, securing external appearance equal to that of the conventional elevator panel formed of expensive metal material, and producing an excellent effect of isolating and absorbing sound, such as noise from the outside.

Another object of the present invention is to provide an elevator panel, which maintains the adhesive resin of a bonded plate to have a predetermined viscosity, and is produced by bending the bonded plate, so that an adhesive resin layer itself is not fractured, and can increase sound-absorbing and vibration-damping characteristics due to such viscosity.

Meanwhile, in light of the sharp increase in the cost of production in the case of using a conventional single sheet made of relatively expensive stainless steel, titanium, etc., an object of the present invention is to provide an elevator panel, in which a surface plate that is exposed to the outside is formed using a thin steel sheet having excellent external appearance and workability, and simultaneously an inner backing plate supporting the surface plate that is formed of a relatively inexpensive steel sheet and is bonded with the surface plate using an adhesive resin having excellent sound-absorbing and vibration-damping characteristics, thereby remarkably reducing the cost of production.

Furthermore, another object of the present invention is to provide an elevator car, in which the above-described elevator panels are fixedly fastened to an elevator car frame, thereby promoting the value of a building due to fine external appearance of the elevator car, absorbing and isolating noise from the outside, and damping vibration.

In addition, yet another object of the present invention is to provide an elevator car, in which elevator panels are produced by bonding heterogeneous or homogeneous plates together using an adhesive resin, and particularly a backing plate is formed of light-weight material, thereby reducing weight thereof by 10% to 20%.

According to another aspect of the present invention, there is provided an elevator panel, which is formed from a bonded plate, and used as a panel for a jamb, an entrance, a car internal finishing material and a car door of an elevator. The elevator panel includes a surface plate; a backing plate backing the surface plate; and an adhesive resin interposed between the surface plate and the backing plate and bonding the surface plate and the backing plate with each other, wherein the adhesive resin has a thickness from about 0.02 mm to about 0.1 mm, whereby excellent sound-absorbing and vibration-damping characteristics are achievable from the elevator panel.

Here, the surface plate may have a thickness from about 0.1 mm to about 0.5 mm, and the backing plate may have a thickness from about 0.5 mm to about 1.9 mm.

Further, the surface plate may be made of stainless steel, aluminum, and copper, which have excellent surface-treatment characteristics and workability, whereas the backing plate may be made from a galvanized steel sheet, a stainless steel sheet, an aluminum sheet, a polyester painted steel sheet, a cold rolled steel sheet, and a pickled and oiled steel sheet.

Also, the surface plate and the backing plate may all be made from a galvanized steel sheet, and the surface plate may be subjected to surface treatment of powder painting in order to increase corrosion resistance and durability thereof.

Furthermore, the surface plate and the backing plate may each have bending rigidity from about 10.5 Nm to about 16.5 Nm.

In addition, the adhesive resin may have viscosity from about 2500 cps to about 4500 cps.

According to another aspect of the present invention, there is provided an elevator car, which is produced using elevator panels having excellent sound-absorbing and vibration-damping characteristics. The elevator car includes an elevator car frame defining a hexagonal cage by a plurality of frames; the elevator panels, which are formed from bonded plates sequentially arranged outside the elevator car frame and having a C-shaped cross section, each having a surface plate, a backing plate backing the surface plate, and an adhesive resin interposed between the surface plate and the backing plate and bonding the surface plate and the backing plate with each other; and reinforcements coupled to C-shaped inner portions of each elevator panel, wherein the sequentially arranged elevator panels are fastened to each other, or are directly fastened to the elevator car frame, and the reinforcements are directly fastened to the elevator car frame.

Here, the surface plate may have a thickness from about 0.1 mm to about 0.5 mm, the backing plate may have a thickness from about 0.5 mm to about 1.9 mm, and the adhesive resin may have a thickness from about 0.02 mm to about 0.1 mm.

Further, the surface plate may be made of stainless steel, aluminum, and copper, which have excellent surface treatment characteristics and workability, and the backing plate may be made from a galvanized steel sheet, a stainless steel sheet, an aluminum sheet, a polyester painted steel sheet, a cold rolled steel sheet, and a pickled and oiled steel sheet. In addition, the surface plate and the backing plate may each have bending rigidity from about 10.5 Nm to about 16.5 Nm, and the adhesive resin may have a viscosity from about 2500 cps to about 4500 cps.

The above and other objects, features, and advantages of the present invention will be more clearly understood from the following detailed description when taken in conjunction with the accompanying drawings.

### BRIEF DESCRIPTION OF THE DRAWINGS

FIG. 1 is a partial perspective view illustrating the structure of a bonded plate according to one embodiment of the present invention;

FIG. 2 is a cross-sectional view illustration taken along the line A-A of FIG. 1;

FIG. 3 is a cross-sectional view illustration of an elevator panel according to the present invention;

FIGS. 4a-4c are schematic front-view illustrations of an elevator to which an elevator panel according to the present invention can be applied;

FIG. 5 is a perspective view illustration of reinforcements that are attached to an elevator panel according to the present invention;

FIG. 6A is a cross-sectional view taken along the line A-A of FIG. 5;

FIG. 6B is a cross-sectional view taken along the line B-B of FIG. 5;

FIG. 7 is a perspective view illustration of an elevator car using elevator panels according to another embodiment of the present invention; and

FIG. 8 is a top plan view illustration of the elevator car of FIG. 7.

### DESCRIPTION OF THE PREFERRED EMBODIMENTS

Hereinafter, an elevator panel and an elevator car using the same, according to the present invention, will be described in greater detail with reference to the accompanying drawings.

### Structure of Elevator Panel

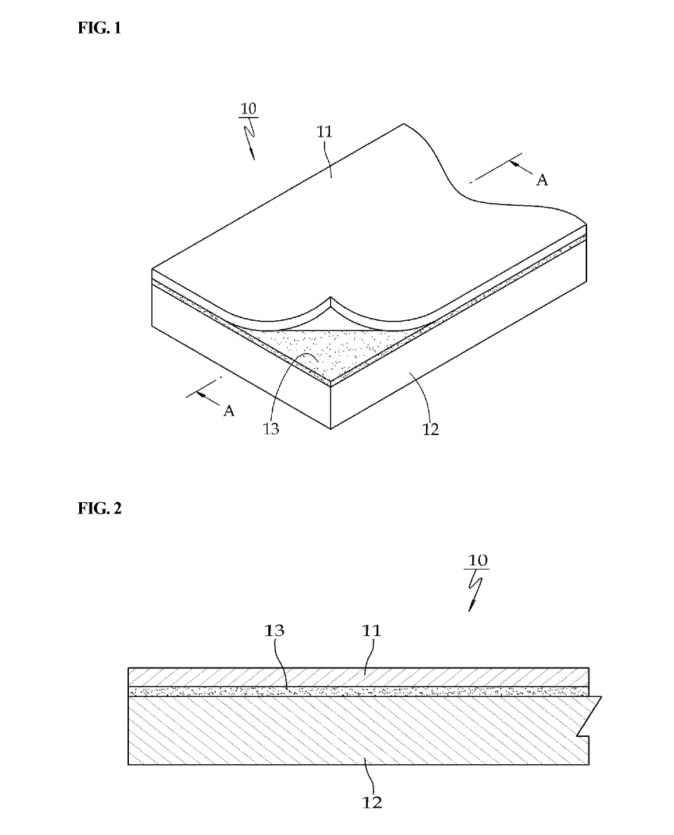

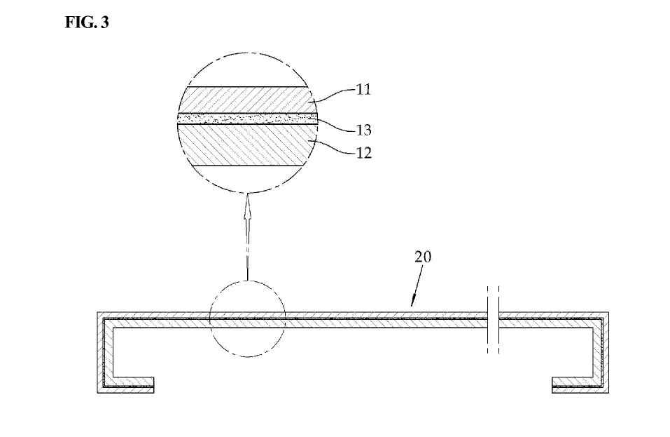

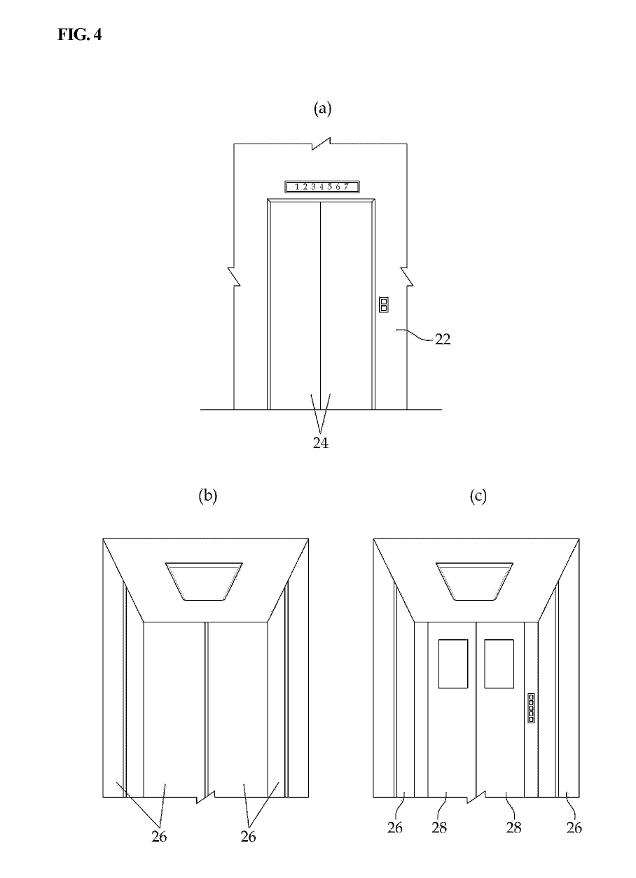

In the accompanying drawings, FIG. 1 is a partial perspective view illustrating the structure of a bonded plate according to an embodiment of the present invention, FIG. 2 is a cross-sectional view taken along the line A-A of FIG. 1, FIG. 3 is a cross-sectional view illustrating an elevator panel according to the present invention, and FIGS. 4a-4c are schematic front views illustration of an elevator to which an elevator panel according to the present invention can be applied.

First, the elevator panel illustrated in FIG. 3 can be formed by bending the bonded plate illustrated in FIGS. 1 and 2. The formed elevator panel is applied to and used for a jamb 22, an entrance 24, a car internal finishing material 26 and a car door 28 of the elevator illustrated in FIG. 4.

As illustrated in FIGS. 1 and 2, the bonded plate 10 according to the present invention includes a surface plate 11, a backing plate 12 backing the surface plate 11, and an adhesive resin 13 that is interposed between the surface plate 11 and backing plate 12 to bond the surface plate 11 and the backing plate 12 with each other.

Preferably, the surface plate 11 is made of stainless steel, aluminum, or copper, each having excellent surface treatment characteristics and workability. The backing plate 12 is selected from a galvanized steel sheet, a stainless steel sheet, an aluminum sheet, a polyester painted steel sheet, a cold rolled steel sheet, or a pickled and oiled steel sheet. More preferably, the surface plate 11 employs any one of the SUS 300 series having excellent surface workability and corrosion resistance (and most preferably SUS304). However, because the elevator panel is merely subjected to simple working (e.g. pattern pressing, bending, seaming, etc.), it can use most types of steel sheets.

Meanwhile, the backing plate 12 is preferably selected from steel sheets having excellent bendability so as to bend the bonded plate 10 to form the elevator panel as well as sufficient strength to back the surface plate 11. Specifically, the backing plate 12 can employ a galvanized steel sheet, a stainless steel sheet, an aluminum sheet, a polyester painted steel sheet, a cold rolled steel sheet, or a pickled and oiled steel sheet. Here, the galvanized steel sheet should be broadly interpreted to include a hot dip galvanized steel sheet, an electrolytic galvanized steel sheet, a galvannealed steel sheet, an aluminum coated steel sheet, a zinc-aluminum alloy coated steel sheet, and so on. In particular, in order to emphasize only functionalities, such as sound-absorbing characteristics, vibration-damping characteristics, etc., of the elevator panel with no regard to external appearance, both the surface plate 11 and the backing plate 12 may be made from galvanized steel sheet. However, in this case, in order to increase the corrosion resistance and durability of the surface plate 11, the surface of the surface plate is preferably subjected to powder painting.

The surface plate 11 and the backing plate 12 of the bonded plate 10 should have proper bendability in order to be bent in a shape of the elevator panel. In order to meet this bendability, the bonded plate 10 is preferably selected from materials having bending rigidity from 10.5 Nm to 16.5 Nm.

The bending rigidity is calculated using a Ross Kerwin Ungar (RKU) method expressed by Equation 1 below:

$$E = \frac{12 ( 1 - {υ}^{2} ) {B}_{c}}{{t}_{c}^{3}} , \qquad Equation 1$$

where B_{c} is the bending rigidity, υ is the Poisson's ratio, and t_{c} is the total thickness.

Particularly, when the bending rigidity is less than 10.5 Nm, the bonded plate 10 is warped by weak force, and thus can be vulnerable to external impact after formation. In contrast, when the bending rigidity is more than 16.5 Nm, the bonded plate 10 has reduced bendability, and thus cannot be smoothly formed into the elevator panel.

The adhesive resin 13 is interposed between the surface plate 11 and the backing plate 12, and functions to bond the surface and backing plates 11 and 12 with each other. Preferably, the adhesive resin 13 is formed at a thickness from 0.02 mm to 0.1 mm. Because the adhesive resin 13 is interposed between the surface plate 11 and the backing plate 12, serving to absorb and isolate sounds such as noise, it enables the entire bonded plate 10 to produce excellent sound-absorbing and vibration-damping effects. In other words, a layer of the adhesive resin 13 functions to bond the surface plate 11 and the backing plate 12, and simultaneously damp vibration applied from the outside, particularly absorb and isolate the noise from the outside.

Preferably, the adhesive resin 13 used in the present invention has viscosity from 2500 cps to 4500 cps. When the viscosity is less than 2500 cps, the viscosity of the adhesive resin 13 is too low, so that the adhesive resin 13 cannot firmly bond the surface plate 11 and the backing plate 12. In contrast, when the viscosity is more than 4500 cps, the viscosity of the adhesive resin 13 is too high, so that, in the case of forming and working the bonded plate 10, part of the cured adhesive resin layer may fracture, or the surface plate of the bonded plate may warp. Thus, the adhesive resin 13 used for the bonded plate of the present invention should maintain the viscosity of a predetermined level in order to guarantee excellent formability. Further, due to such viscosity, the adhesive resin 13 can further increase vibration-damping, sound-absorbing, heat-insulating effects.

Preferably, the surface plate 11 is formed to have a thickness from 0.1 mm to 0.5 mm, the backing plate 12 is formed to have a thickness from 0.5 mm to 1.9 mm, and the adhesive resin 13 bonding the surface plate 11 with the backing plate 12 is formed to have a thickness from 0.02 mm to 0.1 mm. In order to solve the problem that the cost of production sharply increases in the case of using the conventional single steel sheet made of relatively expensive stainless steel and etc., the present invention is technically characterized in that the surface plate 11 exposed to the outside is formed thinly, and simultaneously the backing plate 12 backing the surface plate inside is thickly formed of the relatively inexpensive steel sheet, and is bonded with the surface plate using the adhesive resin 13 having excellent sound-absorbing and vibration-damping characteristics. Preferably, the surface plate 11 is formed to have a thickness from 0.1 mm to 0.5 mm. When the surface plate 11 has a thickness of 0.1 mm or less, it is too thin, and thus may be warped or torn by impact applied from the outside. In contrast, when the surface plate 11 has a thickness of 0.5 mm or more, the effect of reducing the cost of production is relatively lowered. Meanwhile, the adhesive resin is formed to have a thickness from 0.02 mm to 0.1 mm. When the adhesive resin 13 has a thickness of 0.02 mm or less, the sound-absorbing and vibration-damping characteristics are lowered. In contrast, when the adhesive resin has a thickness of 0.1 mm or more, the adhesive resin layer cannot maintain uniform viscosity in the thickness direction.

### Elevator Car Using Elevator Panels

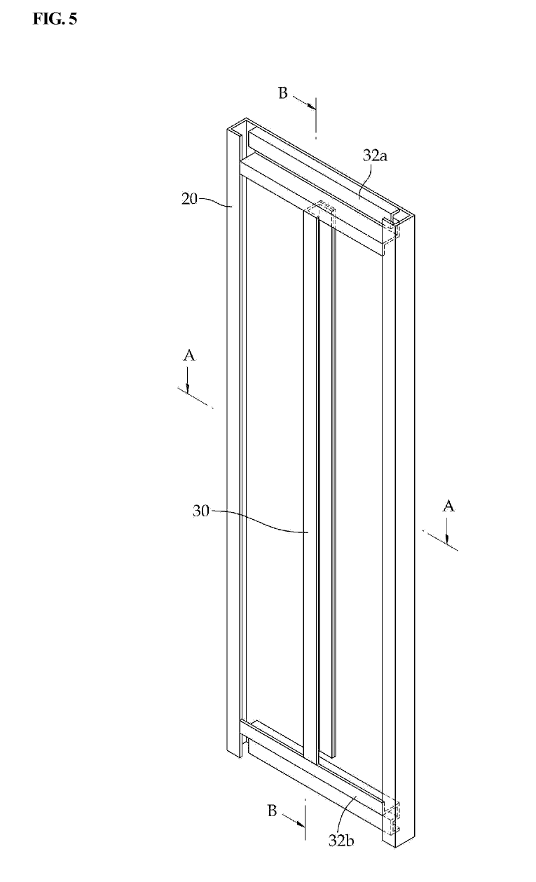

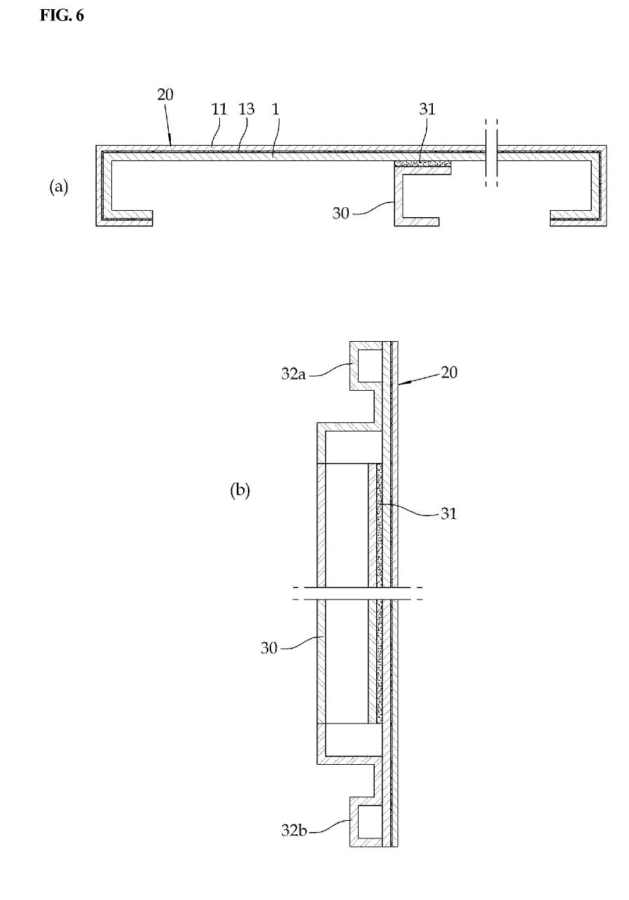

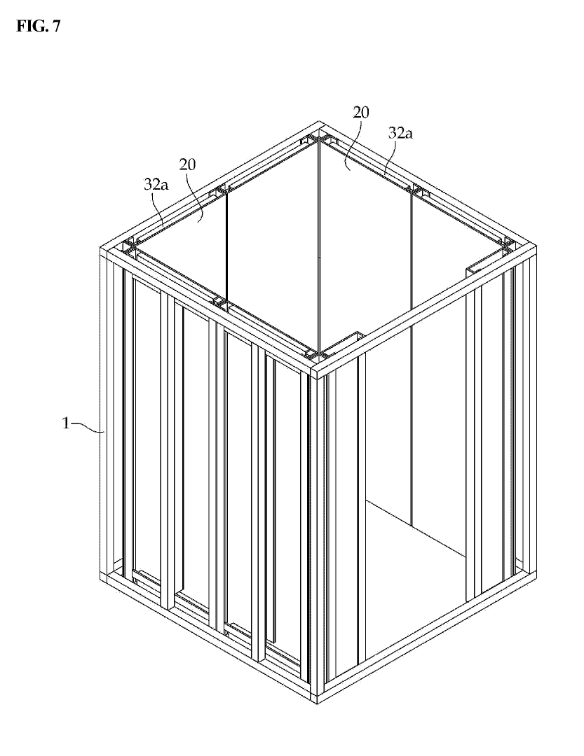

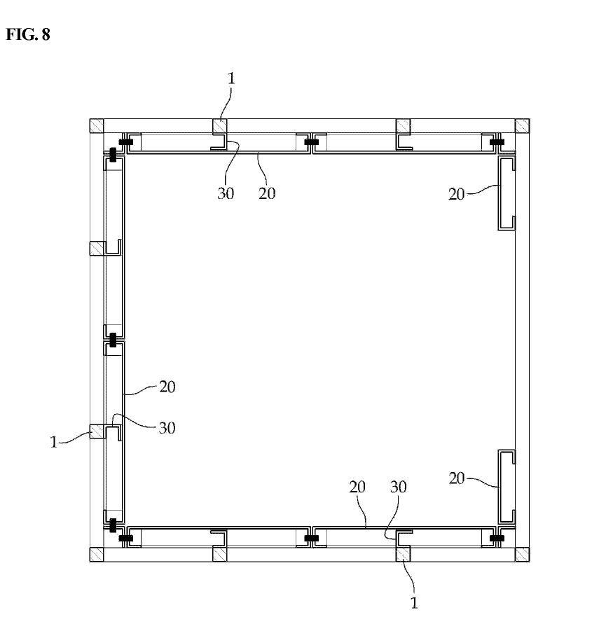

FIG. 5 is a perspective view illustration of reinforcements that are attached to an elevator panel according to the present invention, FIG. 6A is a cross-sectional view taken along line A-A of FIG. 5, FIG. 6B is a cross-sectional view taken along line B-B of FIG. 5, FIG. 7 is a perspective view illustration of an elevator car using elevator panels according to another embodiment of the present invention, and FIG. 8 is a top plan view illustration of the elevator car of FIG. 7.

The elevator car applying the above-described elevator panels will be described below in greater detail with reference to FIGS. 5 through 8.

The elevator car according to another embodiment of the present invention includes an elevator car frame 1 defining a hexagonal cage by a plurality of frames; elevator panels 20, which are formed from bonded plates sequentially arranged outside the elevator car frame 1 and having a C-shaped cross section, each having a surface plate 11, a backing plate 12 backing the surface plate 11, and an adhesive resin 13 interposed between the surface plate 11 and the backing plate 12 to bond the surface and backing plates 11, 12 with each other; and reinforcements 30, 32a and 32b coupled to C-shaped inner portions of each elevator panel 20. Preferably, as illustrated in FIG. 8, the elevator panels 20 are fastened to each other, or are directly fastened to the elevator car frame 1, and the reinforcements 30, 32a and 32b are directly fastened to the elevator car frame 1.

More specifically, the elevator car frame 1 defining the hexagonal cage by connecting the plurality of frames is prepared. Then, the reinforcements 30 are temporarily adhered to the C-shaped inner portions of each elevator panel 20 using an adhesive 31, such as double-sided tape. The reinforcements 30 include first and second horizontal reinforcement portions 32a and 32b, respectively, attached to upper and lower ends of each elevator panel 20 in a horizontal direction, and a third portion 30c connected between the horizontal reinforcements 32a, 32b in a vertical direction. The reinforcement portions 32a and 32b are coupled to the bent portions of each elevator panel 20 by welding or bolting, and the reinforcement portion 30, is also coupled between the horizontal reinforcements 32a, 32b in the vertical direction by welding or bolting. In this manner, the elevator panels to which the reinforcements are coupled are sequentially arranged inside the elevator car frame 1, and the sequentially arranged elevator panels 20 are bolted to each other, or themselves are directly fastened the elevator car frame 1. As a result, the surface plate 11 of each elevator panel is disposed in an inward direction, so that the external appearance of the inside of the elevator car is excellent. Further, the noise and vibration can be blocked from the outside by the sound-absorbing and vibration-damping characteristics of the elevator panels 20, each of which is formed from the bonded plate 10. In addition, each elevator panel 20 is used by mutually bonding the heterogeneous or homogeneous plates using the adhesive resin 13, so that the elevator car can be expected that its weight can be reduced by the range from 10% to 20%, compared to that of the conventional elevator car.

As is apparent from the above description, the present invention has the following effects. First, the bonded plate 10—i.e., the surface plate 11 bonded to the backing plate using the adhesive resin 13, is used as the inventive elevator panel 20, so that the elevator panel 20 allows the adhesive resin layer of the bonded plate 10 to have sound-absorbing and vibration-damping functions. Further, the inventive elevator panel is produced using this bonded plate 10, so that it can remarkably reduce the cost of production, secure external appearance equal to that of the conventional elevator panel formed of expensive metal material, and produce an excellent effect of isolating and absorbing sounds such as noise from the outside.

Second, the inventive elevator panel 20 maintains the adhesive resin 13 of the bonded plate 10 to have a predetermined viscosity, so that, when the inventive elevator panel 20 is produced by bending the bonded plate 10, the adhesive resin layer itself is not fractured, and can increase sound-absorbing and vibration-damping characteristics due to such viscosity.

Third, in order to solve the problem that the cost of production is sharply increased in the case of using the conventional single steel sheet made of relatively expensive stainless steel, titanium, etc., the inventive elevator panel 20 is produced in such a manner that the surface plate 11 exposed to the outside is formed using the thin steel sheet having excellent external appearance and workability, and simultaneously the thicker backing plate 12 supporting the surface plate 11 from the inside is formed from the relatively inexpensive steel sheet and is bonded with the surface plate 11 using the adhesive resin 13 having excellent sound-absorbing and vibration-damping characteristics, so that it can remarkably reduce the cost of production.

Fourth, the inventive elevator panels 20 are fixedly fastened to the elevator car frame 1, so that the inventive elevator car can promote the value of a building due to fine external appearance of the inside of the elevator car, absorb and isolate noise from the outside, and damp vibration.

Fifth, the inventive elevator panel 20 is produced by bonding heterogeneous or homogeneous plates using the adhesive resin, and particularly the backing plate is formed of inexpensive, light-weight material, so that the inventive elevator car can reduce weight thereof by the range from 10% to 20%, compared to the conventional elevator car.

Although the exemplary embodiments of the present invention have been described for illustrative purposes, those skilled in the art will appreciate that various modifications, additions and substitutions are possible, without departing from the scope and spirit of the invention as defined in the accompanying claims.

1. An elevator panel, used as a panel for a jamb, an entrance, a car internal finishing material and a car door of an elevator, the elevator panel comprising:
a surface plate;
a backing plate backing the surface plate; and
an adhesive resin interposed between the surface plate and the backing plate and bonding the surface plate and the backing plate with each other;
wherein the adhesive resin has a thickness from about 0.02 mm to about 0.1 mm; and
wherein the elevator panel provides sound-absorbing and vibration-damping characteristics.

2. The elevator panel set forth in claim 1, wherein the surface plate has a thickness from about 0.1 mm to about 0.5 mm; and
wherein the backing plate has a thickness from about 0.5 mm to about 1.9 mm.

3. The elevator panel set forth in claim 2, wherein the surface plate is formed of any one selected from stainless steel, aluminum, and copper; and
wherein the backing plate is formed from any one selected from the group consisting of a galvanized steel sheet, a stainless steel sheet, an aluminum sheet a polyester painted steel sheet, a cold rolled steel sheet, and a pickled and oiled steel sheet.

4. The elevator panel set forth in claim 2, wherein the surface plate and the backing plate are each formed from a galvanized steel sheet; and
wherein the surface plate is subjected to surface treatment of powder painting.

5. The elevator panel set forth in claim 2, wherein each of the surface plate and the backing plate has bending rigidity from about 10.5 Nm to about 16.5 Nm.

6. The elevator panel set forth in claim 2, wherein the adhesive resin has viscosity from about 2500 cps to about 4500 cps.

7. The elevator panel set forth in claim 1, wherein the surface plate is formed of any one selected from stainless steel, aluminum, and copper; and
wherein the backing plate is formed from any one selected from the group consisting of a galvanized steel sheet, a stainless steel sheet, an aluminum sheet, a polyester painted steel sheet, a cold rolled steel sheet, and a pickled and oiled steel sheet.

8. The elevator panel set forth in claim 1, wherein the surface plate and the backing plate are each formed from a galvanized steel sheet, and
wherein the surface plate is subjected to surface treatment of powder painting.

9. The elevator panel set forth in claim 1, wherein each of the surface plate and the backing plate has bending rigidity from about 10.5 Nm to about 16.5 Nm.

10. The elevator panel set forth in claim 1, wherein the adhesive resin has viscosity from about 2500 cps to about 4500 cps.

11. An elevator car comprising:
an elevator car frame defining a hexagonal cage by a plurality of frames;
a plurality of elevator panels, wherein each of the plurality of elevator panels are formed from bonded plates sequentially arranged outside the elevator car frame and having a C-shaped cross section, each having a surface plate, a backing plate backing the surface plate, and an adhesive resin interposed between the surface plate and the backing plate and bonding the surface plate and the backing plate with each other; and
a plurality of reinforcements coupled to C-shaped inner portions of the each elevator panel;
wherein the sequentially arranged elevator panels are fastened to each other or directly fastened to the elevator car frame, and the reinforcements are directly fastened to the elevator car frame.

12. The elevator car set forth in claim 11, wherein the surface plate has a thickness from about 0.1 mm to about 0.5 mm;
wherein the backing plate has a thickness from about 0.5 mm to about 1.9 mm, and
wherein the adhesive resin has a thickness from about 0.02 mm to about 0.1 mm.

13. The elevator car set forth in claim 12, wherein the surface plate is formed of any one selected from stainless steel, aluminum, and copper; and
wherein the backing plate is formed from any one selected from the group consisting of a galvanized steel sheet, a stainless steel sheet, an aluminum sheet a polyester painted steel sheet, a cold rolled steel sheet, and a pickled and oiled steel sheet.

14. The elevator car as set forth in claim 12, wherein the surface plate and the backing plate each have bending rigidity from about 10.5 Nm to about 16.5 Nm; and
wherein the adhesive resin has viscosity from about 2500 cps to about 4500 cps.

15. The elevator car set forth in claim 11, wherein the surface plate is formed of any one selected from stainless steel, aluminum, and copper; and
wherein the backing plate is formed from any one selected from the group consisting of a galvanized steel sheet, a stainless steel sheet, an aluminum sheet a polyester painted steel sheet, a cold rolled steel sheet and a pickled and oiled steel sheet.

16. The elevator car set forth in claim 11, wherein the surface plate and the backing plate each have bending rigidity from about 10.5 Nm to about 16.5 Nm, and
wherein the adhesive resin has viscosity from about 2500 cps to about 4500 cps.
